(19) United States
(12) Patent Application Publication
(10) Pub. No.: US 2006/0209542 A1
(43) Pub. Date: Sep. 21, 2006

(54) LED based rotating beacon

(75) Inventors: Craig Alan Anderson, Tukwila, WA (US); Dennis N. Anderson, Boise, ID (US); William M. Cresse, Boise, ID (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Preco Electronics, Inc., Boise, ID (US)

(21) Appl. No.: 11/084,334

(22) Filed: Mar. 18, 2005

(51) Int. Cl. F21V 33/00

(52) U.S. Cl. 362/253

(57) ABSTRACT

A rotating beacon employs an array of LEDs mounted on a rotor assembly in a pattern for unidirectional emission wherein the LEDs are excited through noncontact inductive coupling between a load coupling on the rotor assembly and a source coupling on the stator or mount element. In a particular embodiment, a primary sender flat coil of an air gap transformer is disposed concentrically forming a disc and mounted juxtaposed to a secondary receiver flat coil so that power can be conveyed across the air gap while the rotor is in motion. The transferred power excites substantially all of the LED array in a fixed pattern on the rotating mount. In a second embodiment, the air gap transformer has a primary sender coil is mounted coaxially with a secondary receiver coil (which is typically but not necessarily inside the primary coil), so the secondary, with the array can freely rotate and draw power from the source.

### CROSS-REFERENCES TO RELATED APPLICATIONS

NOT APPLICABLE

### STATEMENT AS TO RIGHTS TO INVENTIONS MADE UNDER

### FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISC

NOT APPLICABLE

### BACKGROUND OF THE INVENTION

This invention relates to beacon lamps or warning lamps, such as vehicle-mounted or point-of danger-mounted rotating lamps using light emitting diode (LED) arrays whereby a pattern of repeated flashes appear in a horizontal arc.

In the past, rotating beacons have incorporated standard filament and bright halogen gas incandescent lamps. More recently, LED arrays of various configurations have been suggested for rotating beacon applications. A representative disclosure is found in U.S. Pat. No. 6,183,100. Therein are disclosed arrays of fixedly mounted LEDs disposed to be selectively excited or selectively excited and then reflected by either fixed mirrors, a single array LEDs disposed to have its output reflected by a rotating mirror, and arrays of rotatably mounted LEDs used to emit directly to a target. This last arrangement, shown in FIG. 2A-2C of U.S. Pat. No. 6,183,100, requires a commutator arrangement to allow continuous rotation of an array-bearing rotor. Consequently, the contacts are subject to degradation and possible failure, particularly after extended use or in harsh environments.

Arrangements requiring large numbers of high output LEDs and complex switching schemes have certain disadvantages. For example, a single failure of one switching element may produce a dark area in the 360 degree warning coverage area. Further, large numbers of LEDs in arrays can prove to be unnecessarily expensive.

What is needed is a LED-based rotating beacon which does not use unnecessary LED elements and is not hindered by the danger of electromechanical failure due to contact wear.

### SUMMARY OF THE INVENTION

According to the invention, a rotating beacon employs an array of LEDs mounted on a rotor assembly in a pattern for unidirectional emission wherein the LEDs are excited through noncontact inductive coupling between a load coupling on the rotor assembly and a source coupling on the stator or mount element. In a particular embodiment, a primary sender flat coil of an air gap transformer is disposed concentrically forming a disc and mounted juxtaposed to a secondary receiver flat shaped coil so that power can be conveyed across the air gap while the rotor is in motion. The transferred power excites substantially all of the LED array in a fixed pattern on the rotating mount. In a second embodiment, the air gap transformer has a primary sender coil mounted coaxially with a secondary receiver coil (which is typically but not necessarily inside the primary coil), so the secondary, with the array can freely rotate and draw power from the source.

The invention will be better understood by reference to the following detailed description in connection with the accompanying drawings.

### BRIEF DESCRIPTION OF THE DRAWINGS

FIG. 1 is a perspective view of an LED array mounted on a rotor inductively coupled to a source of power in a platform according to the invention.

FIG. 2 is a side cross-sectional view of a first embodiment of a transformer driver.

FIG. 3 is a side cross-sectional view of a second embodiment of a transformer driver.

FIG. 4 is a circuit diagram of one embodiment of a circuit according to the invention.

### DETAILED DESCRIPTION OF THE INVENTION

The invention can be embodied in various forms, including in uses involving other types of illumination sources. However, the primary use is with LED arrays.

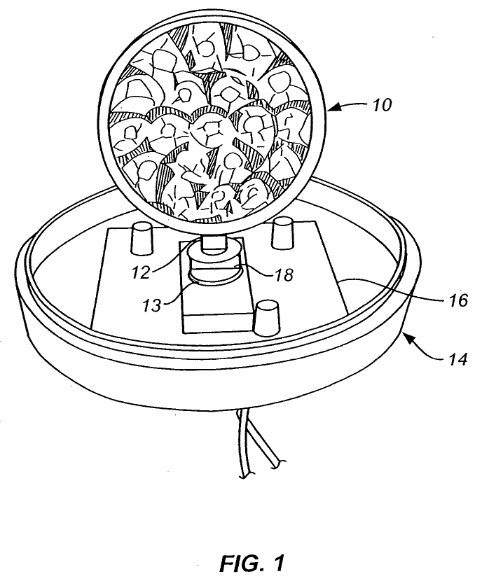

Referring to FIG. 1, a perspective view of an LED array 10 is mounted on a rotor 12. The rotor 12 has a bearing connection through the drive motor to a platform 14. The platform 14 also typically carries an exciter circuit 16 that powers the LED array 10 through a coupling 18, as hereinafter explained.

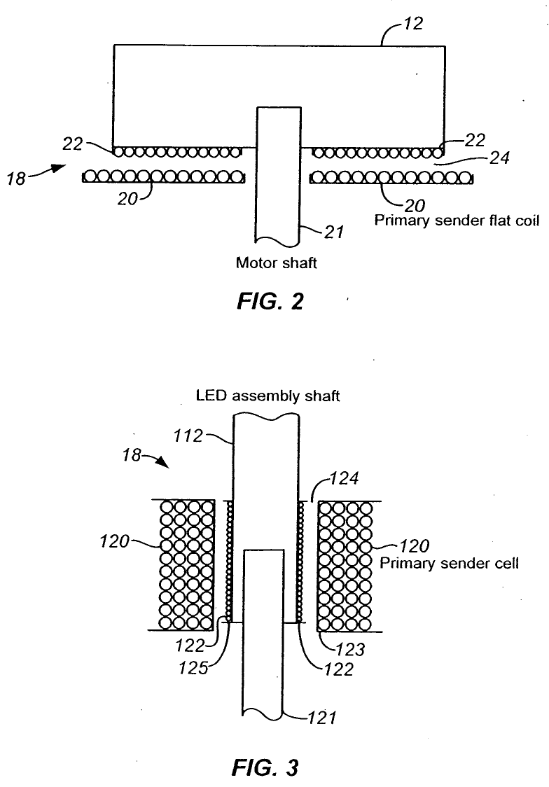

FIG. 2 is a side cross-sectional view of a first embodiment of the coupling 18 in the form of a non-contact transformer driver with a primary winding 20 and a secondary winding 22. The primary winding 20 is coupled to receive power from the exciter circuit 16 in the platform 14. The secondary winding 22 is inductively coupled via an air gap 24 to the primary winding to draw power for the load, namely the LED array 10 (FIG. 1). According to one embodiment of the invention, the primary winding 20 is a flat coil disposed concentrically forming a disc and mounted juxtaposed to the secondary winding 22, the secondary winding being a flat coil for conveying power across the air gap 24 while the rotor 12 is in motion, the rotor 12 being mounted to a motor shaft 21.

FIG. 3 is a side cross-sectional view of a second embodiment of the coupling 18 according to the invention in the form of a non-contact transformer driver with a primary winding 120 and a secondary winding 122. The primary winding 120 is coupled to receive power from the exciter circuit 16 in the platform 14 (FIG. 1). The secondary winding 122 is inductively coupled via an air gap 124 to the primary winding 120 to draw power for the load, namely the LED array 10 (FIG. 1). According to this embodiment of the invention, the primary winding 120 is a coil mounted on a first coil form 123 coaxially with the secondary winding 122 on a second coil form 125, for conveying power in the magnetic field across the air gap 124 while the rotor 112 on the motor shaft 121 is in motion.

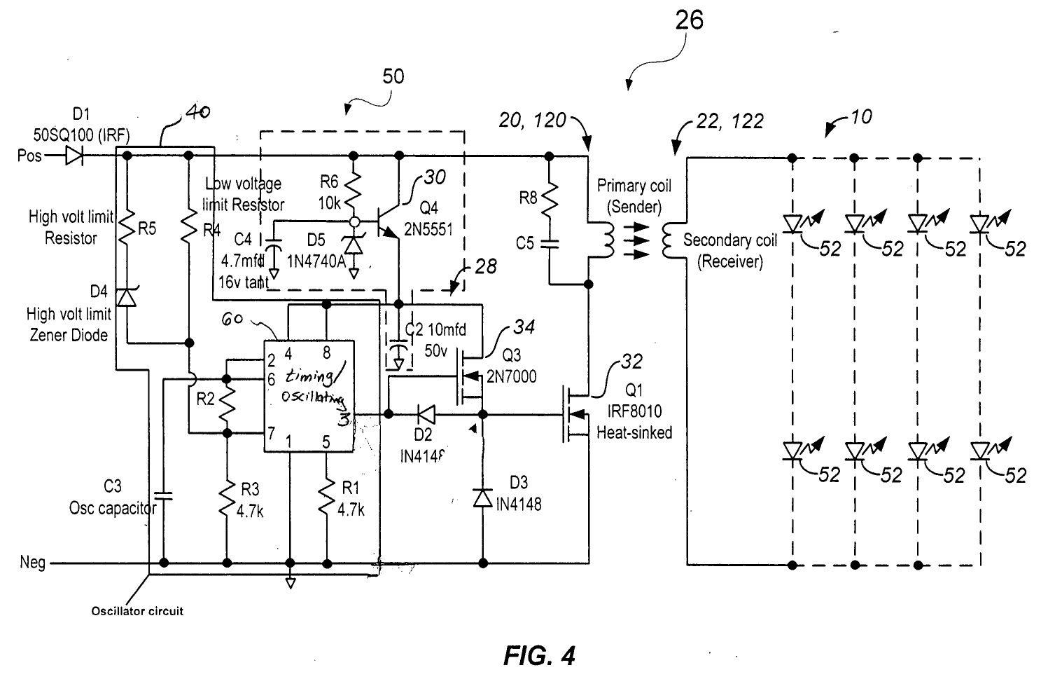

FIG. 4 is a circuit diagram of one embodiment of a driver circuit 26 according to the invention. Driver circuit 26 is shown as including, in part, terminals Pos and Neg adapted to receive D.C. power from a power source (not shown), an oscillator circuit 40, and a voltage regulator circuit 50. Oscillator circuit 40 is shown as including resistors R1, R2, R3, R4, R5, diode D4, capacitor C3 and a timing/oscillating integrated circuit (IC) 60, such as the integrated circuit chip, model no. TLC555 available from Texas Instruments, located at 12500 TI Boulevard, Dallas, Tex., 75243-4136.

Oscillator 40 starts to oscillate when current flows through resistors R2, R4, R5, and diode D4 to the oscillating capacitor C3 and charges this capacitor. When the voltage developing across capacitor C3 reaches an internally preset voltage level, timing/oscillating circuit 60 discharges the voltage developed across capacitor C3 via its terminal 7 and through resistor R2. This cycle is then repeated. As the level of applied voltage increases from, e.g., 9.8 to 58 D.C. volts in one exemplary embodiment, the current flows at a greater rate, which in turn, causes capacitor C3 to charge in a shorter time period, thereby increasing the oscillation frequency. The internal preset voltage level determining when to discharge capacitor C3 is independent of the applied voltage.

The discharge path of the capacitor C3 via terminal 7 of timing/oscillating circuit 60 and through fixed resistor R2 makes the discharge time fixed over varying voltage inputs. The combination of the fixed discharge time and the varying charge time has the effect of narrowing the on-time (active time) of the pulse during each cycle. The pulse appears on terminal 3 of timing/oscillating circuit 60. At 12 volts of supply, the pulse on terminal 3 has a relatively large on-time, up to 50% in one embodiment. At 24 volts, this on-time is almost half of its 12 volt level. Therefore, the on-time of this pulse deceases as the input voltage increases.

The pulse at terminal 3 of timing/oscillating circuit 60, which pulse is asymmetrical and a square-wave pulse, flows through diode D2. Diode D2 is adapted to allow the gate of field effect transistor 32 to discharge to terminal 3 when there is no pulse (i.e., the pulse is inactive), thereby causing the field effect transistor 32 to go into a nonconductive state. Diode D2 is adapted to block terminal 3 from directly charging the gate of transistor 32 during the on-time of the square-wave pulse. The active pulse at terminal 3 of timing/oscillating circuit 60 directly charges the gate of field effect transistor 34, which, in turn, directly charges the gate of transistor 32 causing it to go into a conductive state. The charging of the gate terminal of transistor 32, which causes transistor 32 to conduct, is performed by transistor 34, which has a greater current handling capacity than terminal 3 of timing/oscillating circuit 60. This increase in capacity speeds the transition from non-conduction to conduction of transistor 32, thereby increasing efficiently. Diode D3 provides proper bias for transistor 34.

Voltage regulator 50 that, in turn, is shown as including NPN Transistor 30, resistor R6, diode D5, and capacitors C2, C4, provides a constant supply of voltage to the timing/oscillating circuit 60. In some embodiments, voltage regulator 50 is adapted to supply to timing/oscillating circuit 60, a constant voltage of e.g., 4 to 14 volts, as the input voltage between positive and negative supply terminals Pos and Neg varies from, e.g., 9.8 to 58 volts. Transistors 32, 34 as well as primary winding 20 or 120, in part form, the output stage of driver circuit 26. The load portion of the circuit, the LEDS or other illumination array which are mounted on the rotor 12 (FIG. 1), is represented by the secondary winding 22 or 122 and an array 10 comprising a plurality of series strings of LEDs 52 connected in series-parallel combination.

In operational theory, direct current at any level and supplied from, for example, a 12-48 volt system is applied between the positive terminal Pos and negative input terminal Neg of driver circuit 26. Oscillator circuit 40 oscillates, creating square waves with a duty cycle controlled by the magnitude of the voltage level applied with decreasing ‘on’ time as increasing input voltage is applied. (This is a form of pulse width modulation). As described above, voltage regulator 50 supplies a fixed voltage source for timing/oscillating circuit 60 over the voltage range. Field effect transistor 32, connected in series with the air core coil (primary sender coil 20), provides a path directly from positive voltage input terminal Pos to the negative voltage input terminal Neg. The air core coil 20 may be formed of several turns of wound copper wire on or off a bobbin, as shown for example in FIGS. 2 and 3.

The pulse width modulated square wave power signal is delivered to the control element of the field effect transistor 32 (in this example the gate) either directly from timing/oscillating circuit 60 or through intermediate elements (Q3 transistor 34, and diodes D2, and D3) in order to boost the square wave signal. In response to the pulse width modulated square wave, the field effect transistor 32 first conducts and then blocks current through the air core coil (primary sender coil). In response to the chopped current flowing through the air core coil, an electromagnetic field is created and allowed to decay. The field strength of the field is in direct proportion to the duty cycle of the pulse width modulated square wave created by the drive circuit IC, in the fashion of larger electromagnet field for longer on-time of the duty cycle. In this way, the field strength is maintained at a fixed level over the various levels of voltage applied to the drive circuit by different battery systems or power sources.

A second air core coil (secondary receiver coil 22 or 122) is connected in series with the array 10 formed of a plurality of series strings of LEDs connected in parallel. Alternatively, fluorescent tubes may be used. This connection forms a closed circuit with the secondary winding 22 of the air core coil.

When the secondary winding 22 is brought to close proximity to the primary air core coil, the decaying electromagnet field across the primary air core coil is induced (through transformer action) across the secondary air core coil, thereby energizing the load of light emitting diodes in array 10. The two coils 20, 22 in this fashion form an air core transformer whose primary and secondary coils may physically move freely within each other's electromagnetic fields without brushes or mechanical wear.

The electromagnetic field of the primary air core coil 20 is controlled in strength, thus is the induced field across the secondary 22 also controlled, thereby maintaining proper energy to the light emitting diodes, which benefit from the pulse nature of the cycling energy of the building and decaying electromagnet field. The particular benefit is increased usable light from the light emitting diodes with less heat generation. For a portion of the time (as the field reverses itself), the light emitting diodes are de-energized. The human eye does not perceive this cycle if high enough in frequency and thus rather perceives a constant light. The portion of the time that energy is applied, it is in a high current pulse form, thus giving more light output per unit of time.

Light emitting diodes suffer from heat build up. The two air core coils are free to move or rotate within the confines of the electromagnetic field and still transmit energy from one to the other; the secondary air core coil 22 is driven via a motor (not shown) to rotate within a housing (not shown), thereby passing air over the individual light emitting diodes, cooling them, and providing for a rotating beacon.

The secondary air core coil 22 is free to rotate within the confines of the electromagnetic field of the primary 20 and still receive energy; no brushes or other mechanical connection is required to pass power from the moving to non-moving segments of this structure, a beacon, removing the need for a carbon brush, which has a limited lifetime due to wear. Using a direct drive stepper motor further enhances product life by eliminating the carbon brushes in the motor itself.

The invention has been explained with reference to specific embodiments. Other embodiments will be evident to those of ordinary skill in the art. Therefore, it is not intended that the invention be limited except by the appended claims.

What is claimed is:

1. A rotating beacon comprising:
a platform mount element supporting a primary winding of an air gap transformer, said platform coupled to receive power from an exciter circuit and to convey power to the primary winding for air coupling;
a rotor assembly, said rotor assembly supporting a secondary winding, said secondary winding being air coupled with said primary winding to receive power; and
an array of LEDs mounted on said rotor assembly in a pattern for emission, said array being coupled to receive power from said primary winding for exciting said LEDs.

2. The rotating beacon according to claim 1 wherein said primary winding is a flat coil disposed concentrically forming a disc and mounted juxtaposed to said secondary winding, said secondary being a flat shaped coil for conveying power across the air gap while the rotor is in motion.

3. The rotating beacon according to claim 1 wherein said primary winding is a coil mounted coaxially with said secondary winding, said secondary winding being a solenoid coil, for conveying power across the air gap while the rotor is in motion.

4. The rotating beacon according to claim 3 wherein said secondary winding is disposed primarily within said primary winding.
